(19) United States
(12) Patent Application Publication
(10) Pub. No.: US 2009/0193437 A1
(43) Pub. Date: Jul. 30, 2009

(54) CONCURRENTLY RESPONDING TO EVENTS

(76) Inventors: Frank T. Lee, Cumming, GA (US); Jason D. Wallace, Acworth, GA (US)

Correspondence Address: HOFFMAN WARNICK LLC, 75 STATE ST, 14TH FLOOR, ALBANY, NY, 12207, US

(21) Appl. No.: 12/022,384

(22) Filed: Jan. 30, 2008

(51) Int. Cl. G06F 9/44

(52) U.S. Cl. 719/318

(57) ABSTRACT

As indicated above, the present approach provides an automated communication method and system for concurrently responding to a plurality of events using multiple rules with multiple messaging (notification) timelines (patterns) per event, operating under the constraint of each respective event's dynamic duration or lifespan while considering the state of the event (example: active, paused, inactive). Each individual rule may be configured to govern how messaging agents react with respect to event severities, multiple days and hours of operation of the rule, changes to monitored data points, and multiple messaging (notification) timelines (patterns) with respect to the duration of an event. The multiple messaging timelines (patterns) may differ with respect to how (messaging protocols used and message content/profiles) and to whom messages are sent within multiple varying fragments of time (also referred to herein as escalation levels) encapsulated within the duration or lifespan of an event.

### FIELD OF THE INVENTION

The present invention generally relates to event response. Specifically, the present invention provides an approach to robustly and dynamically provide concurrent responses to a plurality of events occurring in a system.

### BACKGROUND OF THE INVENTION

To be competitive, a company must be able to effectively monitor the performance of its daily business operations. When a significant event occurs, it must be able to notify and dispatch the appropriate resources to address the detected event and notify stakeholders impacted by such an event. Today, there are businesses that maintain a staff just to meet this demand. People are put in place to monitor systems and manually contact the appropriate resources upon detecting certain events. In a fast paced environment, business rules associated with when and how notifications should be sent are often times complex and cumbersome for people to follow. Valuable time is lost while people have to search for this information, determine who needs to be notified (while considering escalations), and then manually notify the appropriate contacts. The practices of manual monitoring and messaging are also vulnerable to human error and prove to be quite costly to sustain. To be competitive, a business must not only be able to effectively handle the necessary monitoring and messaging tasks, they must also do it accurately, efficiently, and cost effectively. Therefore, there exists a need for a solution that solves at least one of the deficiencies in the related art.

### SUMMARY OF THE INVENTION

The present approach provides an automated communication method and system for concurrently responding to a plurality of events using multiple rules with multiple messaging (notification) timelines (patterns) per event, operating under the constraint of each respective event's dynamic duration or lifespan while considering the state of the event (example: active, paused, inactive). Each individual rule may be configured to govern how messaging agents react with respect to event severities, multiple days and hours of operation of the rule, changes to monitored data points, and multiple messaging (notification) timelines (patterns) with respect to the duration of an event. The multiple messaging timelines (patterns) may differ with respect to how (messaging protocols used and message content/profiles) and to whom messages are sent within multiple varying fragments of time (also referred to herein as escalation levels) encapsulated within the duration or lifespan of an event.

A first aspect of the present invention provides a method for concurrently responding to a plurality of events, comprising: detecting the plurality of events; applying a plurality of rules to the plurality of events, the plurality of rules setting forth multiple messaging timelines for each of the plurality of events; and concurrently responding to the plurality of events according to the multiple messaging timelines set forth in the plurality of rules.

A second aspect of the present invention provides a system for concurrently responding to a plurality of events, comprising: a module for detecting the plurality of events; a module for applying a plurality of rules to the plurality of events, the plurality of rules setting forth multiple messaging timelines for each of the plurality of events; and a module for concurrently responding to the plurality of events according to the multiple messaging timelines set forth in the plurality of rules.

A third aspect of the present invention provides a program product stored on a computer readable medium for concurrently responding to a plurality of events, the computer readable medium comprising program code for causing a computer system to: detect the plurality of events; apply a plurality of rules to the plurality of events, the plurality of rules setting forth multiple messaging timelines for each of the plurality of events; and concurrently respond to the plurality of events according to the multiple messaging timelines set forth in the plurality of rules.

A fourth aspect of the present invention provides a method for deploying a system for concurrently responding to a plurality of events, comprising: providing a computer infrastructure being operable to: detect the plurality of events; apply a plurality of rules to the plurality of events, the plurality of rules setting forth multiple messaging timelines for each of the plurality of events; and concurrently respond to the plurality of events according to the multiple messaging timelines set forth in the plurality of rules.

A fifth aspect of the present invention provides a data processing system for concurrently responding to a plurality of events, comprising: a memory medium having instructions; a bus coupled to the memory medium; a processor coupled to the bus that when executing the instructions causes the data processing system to: detect the plurality of events, apply a plurality of rules to the plurality of events, the plurality of rules setting forth multiple messaging timelines for each of the plurality of events, and concurrently respond to the plurality of events according to the multiple messaging timelines set forth in the plurality of rules.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a diagram illustrating multiple messaging timelines per event according to the present invention.

FIG. 2 depicts a diagram illustrating multiple escalation levels within messaging timelines according to the present invention.

FIG. 3 depicts a diagram illustrating multiple varying messaging timelines according to the present invention.

FIG. 4 depicts a diagram illustrating single messaging timelines and reactions according to the present invention.

FIG. 5 depicts a more specific computerized implementation according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Computerized Implementation

### I. General Description

As indicated above, the present approach provides an automated communication method and system for concurrently responding to a plurality of events using multiple rules with multiple messaging (notification) timelines (patterns) per event, operating under the constraint of each respective event's dynamic duration or lifespan while considering the state of the event (example: active, paused, inactive). Each individual rule may be configured to govern how messaging agents react with respect to event severities, multiple days and hours of operation of the rule, changes to monitored data points, and multiple messaging (notification) timelines (patterns) with respect to the duration of an event. The multiple messaging timelines (patterns) may differ with respect to how (messaging protocols used and message content/profiles) and to whom messages are sent within multiple varying fragments of time (also referred to herein as escalation levels) encapsulated within the duration or lifespan of an event.

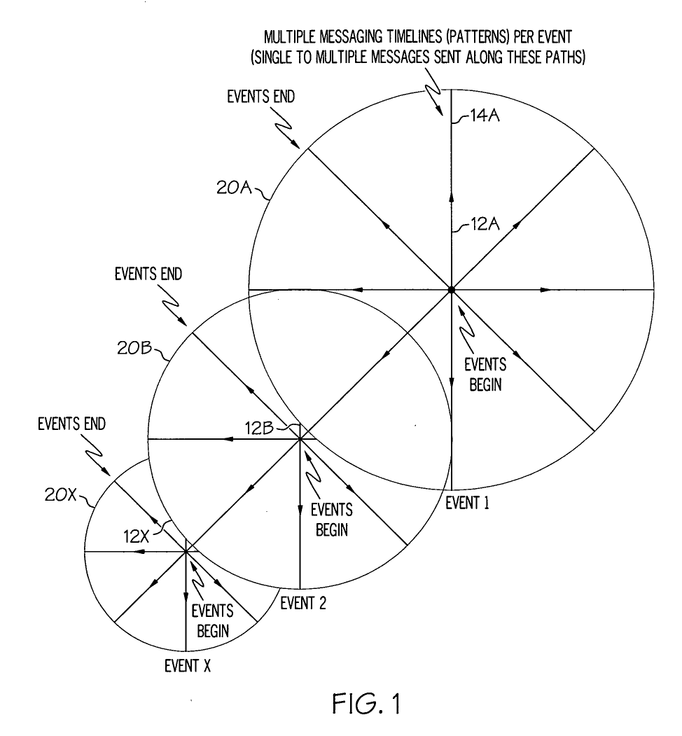

Referring now to FIG. 1, illustrating multiple messaging timelines per event according to the present invention is shown. Specifically, shows that under the present invention multiple events 1-X can occur in an overlapping nature. Each event has a starting point 12A-X, from which multiple messaging timelines (patterns) can emit till an event termination point 20X. For example, event 1 has starting point 12A, from which messaging timeline 14A emits until termination point 20A is reached. Under the present invention multiple events can be current responded to using multiple messaging timelines as set forth in rules configured under the present invention.

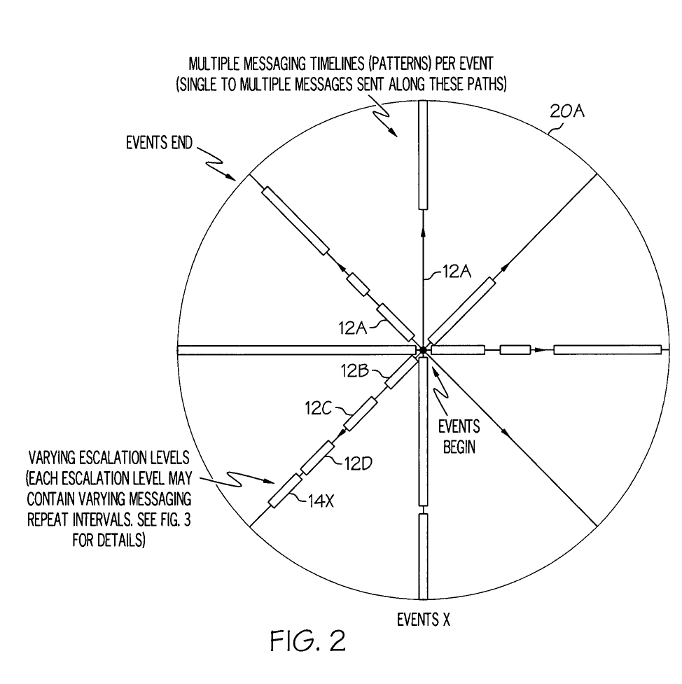

FIG. 2 depicts a diagram illustrating multiple escalation levels within messaging timelines according to the present invention. An escalation level is a fragment of time that is encapsulated within the duration or lifespan of an event. An event may consist of zero to multiple escalation levels whose start and end times are defined by a rule. For example, messaging timeline 14X of event X has escalation levels 22A-D, which differ from other escalation levels along the other messaging timelines.

It should be noted that the content of messages, the recipient of messages, and the rate at which they are sent during this start and end time are also defined by the rules. Instead of sending the same old message over and over again at the same frequency to the same static list of recipients, the present invention allows messages to be sent at: varying frequencies, to varying recipients, with varying message content with consideration for the event, event state, event severity, hours of operation, amount of time since the event occurred, etc. Various instances (timeline) of all this can be setup to run concurrently against each event.

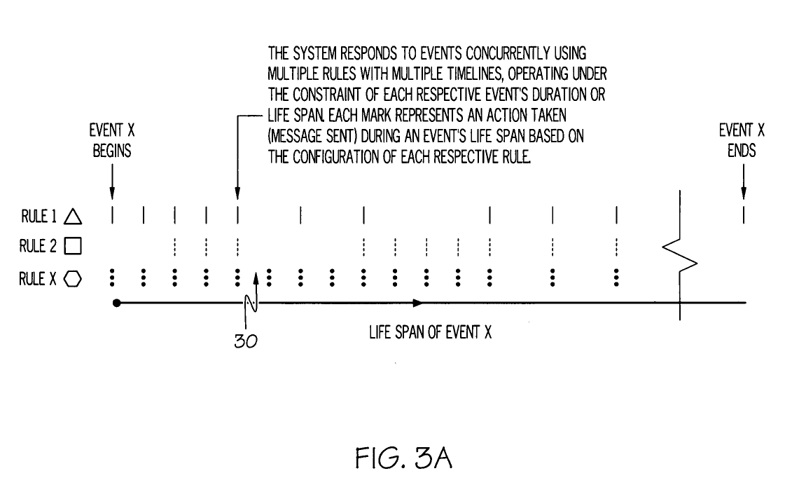

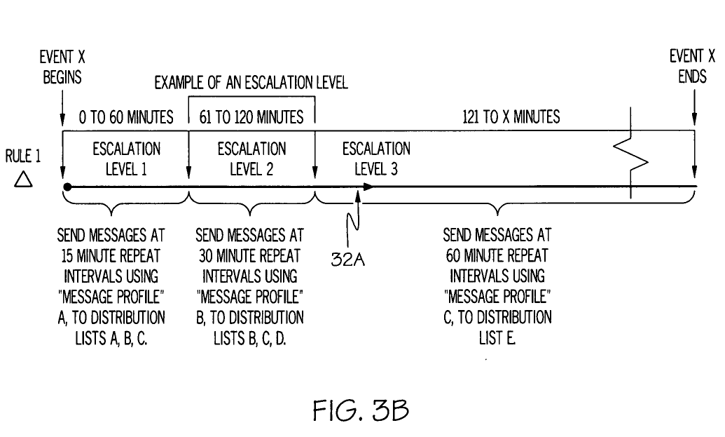

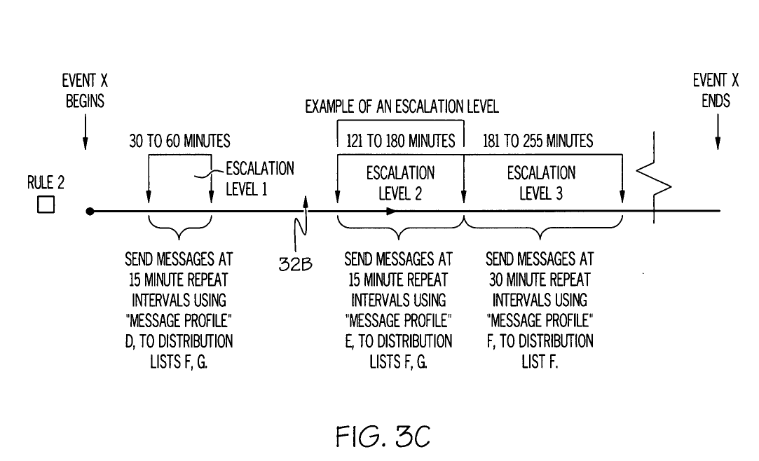

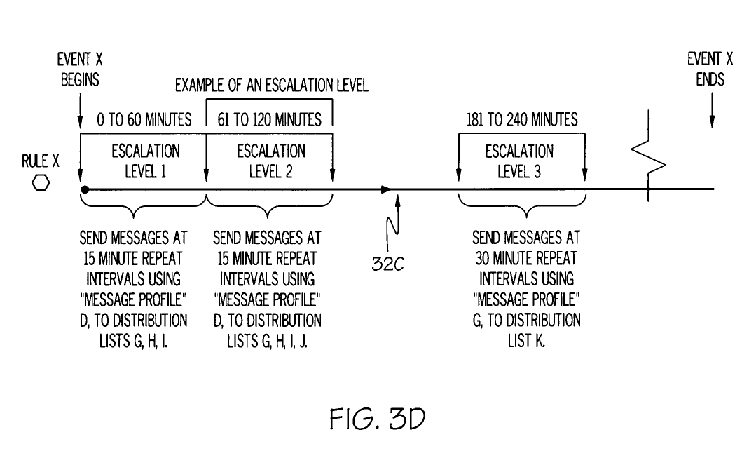

Reference to FIG. 3 is made to further explain this. Timeline 30 shows the lifespan of an event from start to end. The system responds to events concurrently using multiple rules with multiple messaging timelines, operating under the constraint of each respective event's duration or life span. Each mark along timeline 30 represents an action taken (e.g., message sent) during an event's life span based on the configuration of each respective rule. Timelines 32A-C illustrate three illustrative rules. For example, following timeline 32A, the event begins with escalation level 1 existing from minutes 0-60. The rule dictates that during this escalation level, messages will be sent at 15 minute intervals using messaging profile “A” to distribution lists “A, B, and C”. Escalation level 2 exists from minutes 61-120. The rule dictates that during escalation level 2, messages will be sent at 30 minute intervals using messaging profile “B” to distribution lists “B, C, and D”. Finally, escalation level 3 exists from minute 121-x. The rule dictates that during escalation level 3, messages will be sent at 60 minute intervals using messaging profile “C” to distribution lists “E”. Rule timelines 32B-C can be followed for alternative examples.

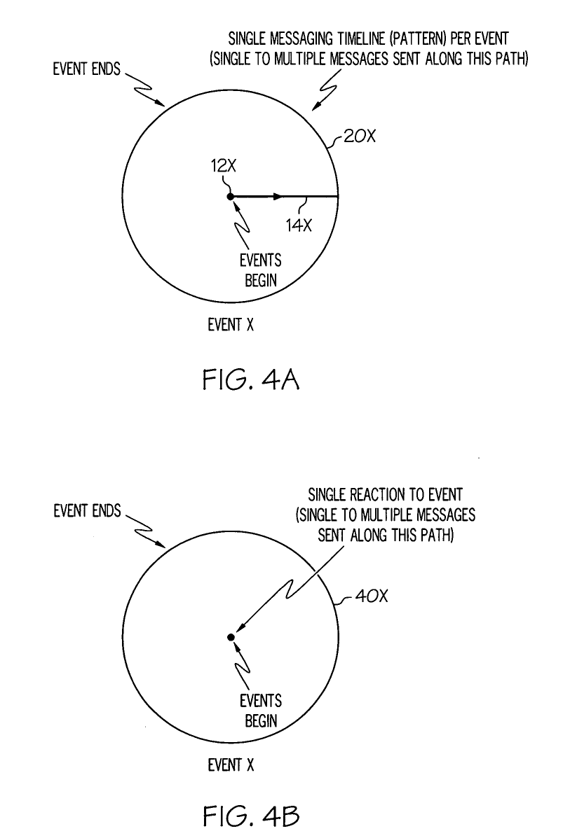

FIG. 4 demonstrates that one of the many ways in which the invention is dynamic. As shown, a event X can have a single messaging timeline 14A from starting point 12X to end point 20X, as well as a single reaction 40X (e.g., such as sending 1 or more messages for the event. One distinction between the present approach and previous approaches is that other inventions address events without consideration for a dynamic event duration and/or only address events with a single reaction per event and without consideration for the state of an event. For example, they do not consider the fact that an event may actually be paused.

### II. Computerized Implementation

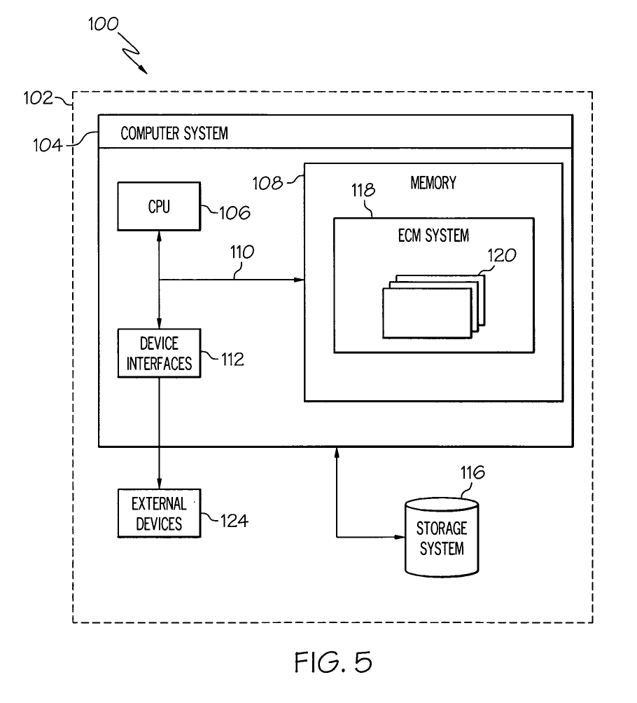

Referring now to FIG. 5, a more detailed diagram of a computerized implementation 100 of the present invention is shown. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others, as indicated above.

As shown, computer system 104 includes a processing unit 106, a memory 108, a bus 110, and input/output (I/O) interfaces 112. Further, computer system 104 is shown in communication with external I/O devices/resources 114 and storage system 116. In general, processing unit 106 executes computer program code, event Response system 118, which is stored in memory 108 and/or storage system 116. While executing computer program code, processing unit 106 can read and/or write data to/from memory 108, storage system 116, and/or I/O interfaces 112. Bus 110 provides a communication link between each of the components in computer system 104. External devices 114 can comprise any devices (e.g., keyboard, pointing device, display, etc.) that enable a user to interact with computer system 104 and/or any devices (e.g., network card, modem, etc.) that enable computer system 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the process(es) of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, I/O interfaces 112 can comprise any system for exchanging information with one or more external device 114. Still further, it is understood that one or more additional components (e.g., system software, math co-processing unit, etc.) not shown in FIG. 5 can be included in computer system 104. However, if computer system 104 comprises a handheld device or the like, it is understood that one or more external devices 114 (e.g., a display) and/or storage system 116 could be contained within computer system 104, not externally as shown.

Storage system 116 can be any type of system (e.g., a database) capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104. It should be understood computer system 104 could be any combination of human, hardware and/or software. It is shown as such to illustrate the functions as described herein.

Shown in memory 108 of computer system 104 is event response system 118 having services/components/modules 120. These items represent the services/components discussed above and represent the teachings of the present invention. For example, modules 120 provide at least the following functions: detecting a plurality of events; applying a plurality of rules to the plurality of events, the plurality of rules setting forth multiple messaging timelines for each of the plurality of events; concurrently responding to the plurality of events according to the multiple messaging timelines set forth in the plurality of rules; and configuring the plurality of rules to govern how messaging agents react with respect to: event severities, event states, multiple days and hours of operation of the plurality of rules, changes to monitored data points, and the multiple messaging timelines with respect to durations of the plurality of events. In general, the concurrently response can comprise communicating messages (e.g., dynamics) according to the multiple messaging timelines. Also, as indicated above, each of the plurality of events can comprise at least zero escalation levels (e.g., a fragment of time) whose start times and end times are defined by the plurality of rules.

While shown and described herein as an event response system, it is understood that the invention further provides various alternative embodiments. For example, in one embodiment, the invention provides a computer-readable/useable medium that includes computer program code to enable a computer infrastructure for providing event response as described herein. To this extent, the computer-readable/useable medium includes program code that implements the process(es) of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 5) and/or storage system 116 (FIG. 5) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to method for providing event response as described herein. In this case, the service provider can create, maintain, support, etc., a computer infrastructure, such as computer infrastructure 102 (FIG. 5) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for providing event response as described herein. In this case, a computer infrastructure, such as computer infrastructure 102 (FIG. 5), can be provided and one or more systems for performing the process of the invention can be obtained (e.g., created, purchased, used, modified, etc.) and deployed to computer infrastructure 102. To this extent, the deployment of a system can comprise one or more of: (1) installing program code on a computing device, such as computer system 104 (FIG. 5), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for concurrently responding to a plurality of events, comprising:
detecting the plurality of events;
applying a plurality of rules to the plurality of events, the plurality of rules setting forth multiple messaging timelines for each of the plurality of events; and
concurrently responding to the plurality of events according to the multiple messaging timelines set forth in the plurality of rules.

2. The method of claim 1, further comprising configuring the plurality of rules to govern how messaging agents react with respect to: event severities, event states, multiple days and hours of operation of the plurality of rules, changes to monitored data points, and the multiple messaging timelines with respect to durations of the plurality of events.

3. The method of claim 1, the concurrently responding comprising concurrently responding to the plurality of events by communicating messages according to the multiple messaging timelines.

4. The method of claim 3, the messages being dynamic messages.

5. The method of claim 1, each of the plurality of events comprising at least zero escalation levels whose start times and end times are defined by the plurality of rules.

6. The method of claim 5, each of the at least zero escalation levels comprising a fragment of time.

7. A system for concurrently responding to a plurality of events, comprising:
a module for detecting the plurality of events;
a module for applying a plurality of rules to the plurality of events, the plurality of rules setting forth multiple messaging timelines for each of the plurality of events; and
a module for concurrently responding to the plurality of events according to the multiple messaging timelines set forth in the plurality of rules.

8. The system of claim 7, further comprising a module for configuring the plurality of rules to govern how messaging agents react with respect to: event severities, event states, multiple days and hours of operation of the plurality of rules, changes to monitored data points, and the multiple messaging timelines with respect to durations of the plurality of events.

9. The system of claim 7, the module for concurrently responding being configured to concurrently respond to the plurality of events by communicating messages according to the multiple messaging timelines.

10. The system of claim 9, the messages being dynamic messages.

11. The system of claim 7, each of the plurality of events comprising at least zero escalation levels whose start times and end times are defined by the plurality of rules.

12. The system of claim 11, each of the at least zero escalation levels comprising a fragment of time.

13. A program product stored on a computer readable medium for concurrently responding to a plurality of events, the computer readable medium comprising program code for causing a computer system to:
detect the plurality of events;
apply a plurality of rules to the plurality of events, the plurality of rules setting forth multiple messaging timelines for each of the plurality of events; and
concurrently respond to the plurality of events according to the multiple messaging timelines set forth in the plurality of rules.

14. The program product of claim 13, the computer readable medium further comprising program code for causing the computer system to configure the plurality of rules to govern how messaging agents react with respect to: event severities, event states, multiple days and hours of operation of the plurality of rules, changes to monitored data points, and the multiple messaging timelines with respect to durations of the plurality of events.

15. The program product of claim 13, the computer readable medium further comprising program code for causing the computer system to concurrently respond to the plurality of events by communicating messages according to the multiple messaging timelines.

16. The program product of claim 15, the messages being dynamic messages.

17. The program product of claim 13, each of the plurality of events comprising at least zero escalation levels whose start times and end times are defined by the plurality of rules.

18. The program product of claim 17, each of the at least zero escalation levels comprising a fragment of time.

19. A method for deploying a system for concurrently responding to a plurality of events, comprising:
providing a computer infrastructure being operable to:
detect the plurality of events;
apply a plurality of rules to the plurality of events, the plurality of rules setting forth multiple messaging timelines for each of the plurality of events; and
concurrently respond to the plurality of events according to the multiple messaging timelines set forth in the plurality of rules.

20. The method of claim 19, computer infrastructure being further operable to: configure the plurality of rules to govern how messaging agents react with respect to: event severities, event states, multiple days and hours of operation of the plurality of rules, changes to monitored data points, and the multiple messaging timelines with respect to durations of the plurality of events.
